(19) United States
(12) Patent Application Publication
(10) Pub. No.: US 2007/0099682 A1
(43) Pub. Date: May 3, 2007

(54) Environmentally-friendly mobile phone

(75) Inventor: Ga-Lane Chen, Fremont, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/478,411

(22) Filed: Jun. 28, 2006

(30) Foreign Application Priority Data
Oct. 28, 2005 (CN) 200510100819.6

(51) Int. Cl. H04M 1/00

(52) U.S. Cl. 455/575.1

(57) ABSTRACT

An exemplary environmentally-friendly mobile phone includes a main body and a housing enclosing the main body therein. The housing is made of bamboo. The housing has an outer surface and a coating containing nanoparticles is formed on the outer surface thereof The environmentally-friendly multifunctional mobile phone is friendly to environment and users due to having functions such as sterilizing, deodorizing, antifouling and self-cleaning, internet browsing, listening to MP3, taking photographs, infrared and bluetooth transmission, wireless 3G communication, having microdrive, storing changes and so on.

### TECHNICAL FIELD

The present invention generally relates to mobile phones, and more particularly to an environmentally-friendly multifunctional mobile phone.

### BACKGROUND

Originally, mobile phones were only designed as a portable telephone. However, as the technology has evolved, mobile phones have incorporated features of many consumer electronic products to form a multifunctional mobile phone. A multifunctional mobile phone can provide diversified services for users. Functions such as MP3 player, ringtone and wallpaper download, mobile games, and photography are becoming more and more common and popular. The multifunctional mobile phone has brought many services to people, yet the functions of a typical mobile phone are unsatisfactory for customers who continue to demand more features.

Nowadays many people are concerned about the environment. Conventionally, mobile phones use metals or plastics in their construction. However, metals and plastics are not necessarily satisfying materials. For example, metals are usually expensive and plastics usually need electroplating to improve property thereof, so that mobile phones have high cost. Furthermore, these materials are prone to absorbing contamination and bacterium, which can be harmful to health of mobile phones users. In particularly, it is worth mentioning that plastics can cause environmental pollution because those plastics are not dissoluble by natural decomposition. Thus, wastes of these products are harmful to environment.

What is needed, therefore, is an environmentally-friendly mobile phone.

### SUMMARY

A preferred embodiment provides an environmentally-friendly mobile phone. The environmentally-friendly mobile phone includes a main body and a housing enclosing the main body therein. The housing is made of bamboo. The housing has an outer surface and a coating containing nanoparticles is formed on the outer surface thereof.

### BRIEF DESCRIPTION OF THE DRAWING

Many aspects of the present mobile phone can be better understood with reference to the following drawing. The components in the drawing are not necessarily drawn to scale, the emphasis instead being placed upon clearly illustrating the principles of the present embodiment. Moreover, in the drawing, like reference numerals designate corresponding parts throughout.

FIG. 1 is a schematic view of an environmentally-friendly mobile phone in accordance with a preferred embodiment.

### DETAILED DESCRIPTION OF PREFERRED EMBODIMENTS

The preferred embodiment will now be described in detail below and with reference to the drawing.

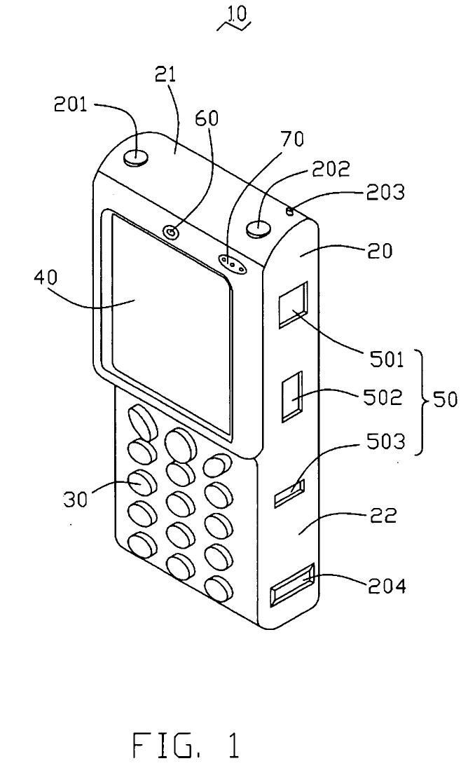

Referring to FIG. 1, an environmentally-friendly mobile phone 10 is provided in accordance with the preferred embodiment. The environmentally-friendly mobile phone 10 includes a main body (invisible in FIG. 1) and a housing 20 enclosing the main body therein.

The housing 20 is made of bamboo. Bamboo is an environmentally-friendly material because bamboo is natural and recyclable. Additionally, bamboo is so flexible that it can be made to any shape to meet personal tastes. In order to increase the mechanical durability, gamma-rays can be used to pretreat bamboo used for making the housing 20. The bacteria, moisture, debris and contamination on bamboo can be cleaned by gamma-rays pretreatment. In addition, a hardness, density and durability of bamboo can be enhanced.

A coating is formed on an outer surface of the housing 20. The coating contains nanoparticles. The nanoparticles are selected from a group consisting of titanium dioxide, silver, zinc dioxide and any appropriate combination thereof The nanoparticles have particle size of in a range from 10 nanometers to 20 nanometers.

For example, titanium dioxide is a good photocatalyst. When the titanium dioxide is irradiated with light, dissociative electrons and positive holes are generated. The strong oxidative potential of the positive holes oxidize and decompose water thereby creating hydroxyl radicals. The hydroxyl radicals can oxidize nearly all organic substances and part inorganic substances directly into carbon dioxide, and destroy cell membrane of bacterium and protein of solidified virus to reach the aim of killing and eliminating bacterium. Therefore, the coating containing nano titanium dioxide has functions of sterilizing, deodorizing, antifouling and self-cleaning. In addition, nano silver and nano zinc dioxide are also characteristic of sterilizing, deodorizing and antifouling. So, the coating can be a titanium dioxide nano-coating, a silver nano-coating, a zinc dioxide nano-coating or any combination thereof. In result, the housing 20 made of bamboo having the coating on the outer surface thereof also has functions such as sterilizing, deodorizing, antifouling and self-cleaning.

A thickness of the coating is in a range from 10 nanometers to 1000 nanometers. Preferably, the thickness of the coating is in a range from 20 nanometers to 500 nanometers.

The environmentally-friendly mobile phone 10 may include a keypad 30 and a display 40 that are arranged in a front side of the housing 20. The display 40 can be a transflective display. The transflective display is capable of operating in both reflective and transmissive modes. In the reflective mode, ambient light reflected by elements within the display provides an image to a viewer. A transmissive mode is advantageous for such a display in a faint circumstance with insufficient ambient light. In the transmissive mode, the light used to provide the image is generated by a backlight. So, the transflective display can be easily seen in the dark or strong sunlight circumstances.

The housing 20 has a first sidewall 21 defined at a top thereof and a second sidewall 22 defined at a lateral side thereof. A transmission interface 201, an emergency switch 202 and a power switch 203 are arranged in the first sidewall 21 of the housing 20. The transmission interface 201 can be, for example, an infrared data interface or a bluetooth interface. In the preferred embodiment, the transmission interface 201 is an infrared data interface. The transmission interface 201 is connected to a transceiver such as infrared data association (IrDA) compatible transceiver inside the housing 20 that enables communication with other devices, such as printers, local area networks (LANs), or laptops. The emergency switch 202 can be connected to emergency telephone numbers such as 911. The emergency numbers also can be modified according to each user. While an accident or an emergency is happening, the emergency switch 202 can be pressed thereby transmitting a signal to an intended receiver and simultaneously the mobile phone will sound the alarm for help.

The environmentally-friendly mobile phone 10 may further include a camera module 60 having an image sensor. The camera module 60 can be on any section of the housing 20. In the preferred embodiment, the camera module 60 is an auto focus lens module and mounted on the upside of the display 40. The imager sensor can be selected from charge couple device (CDD) image sensor and complementary metal-oxide semiconductor (CMOS) image sensor. A resolution of the image sensor may be in a range from 0.3 megapixels to 8 megapixels.

Preferably, a speaker 70 is mounted on either side of the camera module 60 in the preferred embodiment.

The environmentally-friendly mobile phone 10 further includes a number of connector interfaces 50 arranged in the second sidewall 22 of the housing 20. In the preferred embodiment, the connector interfaces 50 include an MP3 interface 501, a compact disk/digital video disk (CD/DVD) interface 502 and a hard disk interface 503. It can be understood that the MP3 interface 501, the CD/DVD interface 502 and the hard disk interface 503 can be in no particular order. The MP3 interface is connected to an MP3 module inside the housing 20. The CD/DVD interface 502 can be connected to a CD/DVD read-only memory (ROM) device outside which can accept not only common CD/DVDs but also blue-ray DVDs. The hard disk interface 503 is connected to a microdrive inside the housing 20. The microdrive has memory capacity from 2 gigabytes to 200 gigabytes. The connector interfaces 50 all are controlled by a control system inside the housing 20.

Additionally, a third generation (3G) transceiver and receiver provided inside the housing 20 can also perform downloading or uploading. Furthermore, it is possible to transmit signals between the environmentally-friendly mobile phone 10 and a personal computer.

A cavity is defined inside the housing 20 and an opening 204 is defined in the second sidewall 22 of the housing 20 in communication with the cavity The opening 204 is rectangular. So, the cavity can serve as a coin bank for accommodating coins therein.

In brief, the environmentally-friendly mobile phone 10 have many other functions except for sending text messages and make voice calls. The functions include internet browsing, listening to MP3, taking photographs, infrared and bluetooth transmission, wireless 3G communication, having microdrive, storing changes and so on. In particular, the environmentally-friendly mobile phone 10 is very friendly to environment and users due to having functions such as sterilizing, deodorizing, antifouling and self-cleaning.

While certain embodiment have been described and exemplified above, various other embodiments will be apparent to those skilled in the art from the foregoing disclosure. The present invention is not limited to the particular embodiment described and exemplified but is capable of considerable variation and modification without departure from the scope of the appended claims.

I claim:

1. An environmentally-friendly mobile phone, comprising:
a main body, and
a housing enclosing the main body therein, the housing being comprised of bamboo, the housing having an outer surface and a coating comprised nanoparticles formed on the outer surface thereof.

2. The environmentally-friendly mobile phone as claimed in claim 2, wherein the nanoparticles are selected from a group consisting of titanium dioxide, siliver, zincum dioxide and any combination thereof.

3. The environmentally-friendly mobile phone as claimed in claim 1, wherein a thickness of the coating is in a range from 10 nanometers to 1000 nanometers.

4. The environmentally-friendly mobile phone as claimed in claim 3, wherein a thickness of the coating is in a range from 20 nanometers to 500 nanometers.

5. The environmentally-friendly mobile phone as claimed in claim 1, wherein the bamboo of the housing is pretreated by gamma rays.

6. The environmentally-friendly mobile phone as claimed in claim 1, further comprising a transflective display.

7. The environmentally-friendly mobile phone as claimed in claim 1, further comprising a camera module having an image sensor.

8. The environmentally-friendly mobile phone as claimed in claim 7, wherein a resolution of the image sensor is in a range from 0.3 megapixels to 8 megapixels.

9. The environmentally-friendly mobile phone as claimed in claim 1, further comprising a transmission interface.

10. The environmentally-friendly mobile phone as claimed in claim 9, wherein the transmission interface is selected from a group consisting of infrared data interface and blue tooth interface.

11. The environmentally-friendly mobile phone as claimed in claim 1, further comprising an emergency switch configured for transmitting a signal to an intended receiver in case of an emergency.

12. The environmentally-friendly mobile phone as claimed in claim 1, further comprising a plurality of connector interfaces arranged in the housing.

13. The environmentally-friendly mobile phone as claimed in claim 12, wherein the connector interfaces comprise an MP3 interface, a CD/DVD interface, and a hard disk interface.

14. The environmentally-friendly mobile phone as claimed in claim 1, further comprising a cavity defined inside the housing configured for accommodating coins therein and an opening defined in a sidewall of the housing in communication with the cavity.
